(19) United States
(12) Patent Application Publication
(10) Pub. No.: US 2016/0369194 A1
(43) Pub. Date: Dec. 22, 2016

(54) INTEGRATED METHOD AND APPARATUS BASED ON PULSATING FLUIDIZATION FOR LIGNITE DE-ASHING AND DEHYDRATION

(71) Applicant: CHINA UNIVERSITY OF MINING AND TECHNOLOGY, Xuzhuo (CN)

(72) Inventors: Chenlong Duan, Xuzhou (CN); Yuemin Zhao, Xuzhou (CN); Liang Dong, Xuzhou (CN); Zhenfu Luo, Xuzhou (CN); Jie Zhao, Xuzhou (CN); Keji Lv, Xuzhou (CN)

(21) Appl. No.: 15/029,698

(22) PCT Filed: Jan. 14, 2015
(86) PCT No.: PCT/CN2015/070653

§ 371 Date: Sep. 7, 2016

(30) Foreign Application Priority Data
Jan. 20, 2014 (CN) 201410024794.5

(51) Int. Cl. C10L 5/04; F26B 21/00; F26B 3/092; F26B 17/10; C10L 9/00; C10L 9/08

(52) U.S. Cl. CPC C10L 5/04; C10L 9/00; C10L 9/08; F26B 3/0926; F26B 17/106; F26B 21/003; F26B 21/004; C10L 2290/08; C10L 2290/06; C10L 2290/60

(57) ABSTRACT

In the sorting bed, the material to be sorted enters into the pulsating hot air drying stage, and is dried and upgraded under the effect of air flow and high-temperature hot air, the material enters into the pulsating cold wind sorting stage under the effect of scraper conveyors which are parallely arranged up and down inside. The light products and heavy products sorted and layered are respectively conveyed to fine coal and gangue discharging outlets at both ends of the sorting machine. The float and hypostasis at the corresponding discharging ends are respectively discharged by light product discharging wheel and heavy product discharging wheel. At the discharging ends, the material is removed from the sorted light material and heavy material and the medium is purified and recycled to use through subsequent process. The dry sorted air containing vapor and dust is purified and recycled through a subsequent dust removal process.

### FIELD OF THE INVENTION

The present invention relates to an integrated method and apparatus for lignite de-ashing and dehydration, in particular to an integrated method and apparatus based on pulsating fluidization for lignite de-ashing and dehydration.

### BACKGROUND OF RELATED ART

Though the lignite resource reserve is abundant in China, the level of exploitation, processing, and utilization of lignite resource is low. Owing to the high ash content and high moisture content in lignite, the lignite has to be treated by de-ashing and dehydration for upgrading before it can be used; the conventional wet coal dressing techniques are not suitable for use in the lignite de-ashing process, because lignite tends to be argillized when it encounters water. The existing lignite dehydration and upgrading techniques can be used only to remove the moisture content from lignite partially, but cannot realize a coal sorting effect; the existing wet coal dressing techniques cannot take a lignite de-ashing and dehydration effect as well.

### SUMMARY OF THE INVENTION

Technical problem: The object of the present invention is to provide an integrated method and apparatus based on pulsating fluidization for lignite de-ashing and dehydration, to solve the problem that the existing wet coal dressing techniques cannot take an lignite de-ashing and dehydration effect.

Technical scheme: The object of the present invention is attained as follows: An integrated method and apparatus based on pulsating fluidization for lignite de-ashing and dehydration, wherein,

The method is implemented through the following steps:

(1) generation and control of pulsating airflow: air is deoxidized in an air purifier, and then is blasted by a blower into an air storage and pressure regulation tank, where the air pressure is regulated and the airflow is split into two branches: one branch of airflow passes through a first electric valve, a first flow meter, an air heater and a first butterfly valve sequentially, and is used as pulsating drying hot wind; the other branch of air passes through a second electric valve, a second flow meter and a second butterfly valve sequentially, and is used as pulsating sorting cold wind; the flow-rate, temperature, pressure and pulsation frequency of the airflow are controlled through sensors, transducer and electric motor according to the requirements of material properties, and moisture content and ash content specification of product by real-time feedback control through a PLC.

(2) dehydration and de-ashing based on pulsating fluidization: the material is fed through a feed inlet into a drying zone, the lower part of the drying zone is connected to hot wind distribution chamber through high-temperature resistant and anti-clogging wind distribution plates, and the material fed into the drying zone is dried and dehydrated under the effect of the high flow-rate and high-temperature pulsating airflow supplied through a hot wind pipe; the dried material enters into the two cold wind sorting stages under the effect of scraper conveyors which are parallelly arranged up and down inside, the lower parts of two cold wind sorting stages are connected to left and right normal temperature wind distribution chambers respectively through high-temperature resistant and anti-clogging wind distribution plates, and the dried material in the cold wind sorting stages are sorted and stratified under the effect of low flow-rate and normal temperature pulsating airflow supplied through a cold wind pipe; the sorted and stratified light products and heavy products are conveyed under the scraper conveyors to fine coal outlets and gangue discharging outlets at the right and left ends of the sorting machine respectively; thus, the moist material is dried and sorted in an integrated manner.

The apparatus comprises a pulsating airflow generating and controlling apparatus, and an integrated apparatus based on pulsating fluidization for de-ashing and dehydration.

The pulsating airflow generating and controlling apparatus comprises: an air purifier, a blower, a first transducer 1, a pressure regulation tank, a first electric valve, a second electric valve, a first flow meter, a second flow meter, a heater, a first butterfly valve, a first electric motor, a second transducer, a second butterfly valve, a second electric motor, a third transducer, a pressure sensor, a temperature sensor, a PLC controller, an upper computer and an integrated apparatus based on pulsating fluidization for de-ashing and dehydration; the air purifier is connected to the blower, a output terminal of the PCL controller is connected to the control terminal of the blower through the first transducer; the output port of the blower is connected to the first electric valve and the second electric valve through the pressure regulation tank simultaneously, the first electric valve is connected to a hot wind pipe of the integrated apparatus based on pulsating fluidization for de-ashing and dehydration through the first flow meter, the heater and the first butterfly valve serially, the second transducer is connected to the first butterfly valve through the first electric motor; the second electric valve is connected to a cold wind pipe of the integrated apparatus based on pulsating fluidization for de-ashing and dehydration through the second flow meter and the second butterfly valve, and the third transducer is connected to the second butterfly valve through the second electric motor; an output terminal of the PLC controller is connected to the control terminals of the second transducer and third transducer; an output terminal of the PLC controller is connected to control terminals of the first electric valve and second electric valve simultaneously; the output terminals of the first flow meter, second flow meter, heater, pressure sensor and temperature sensor are connected to the input terminals of the PLC controller.

The integrated apparatus based on pulsating fluidization for de-ashing and dehydration comprises: a left dust removal port, a right dust removal port, a feed inlet, a fine coal discharging outlet, a gangue discharging outlet, driving wheels, scraper conveyors, driven wheels, a drying zone, a left sorting zone, a right sorting zone, reverse wheels, tension wheels, a hot wind distribution chamber, a left wind distribution chamber, a right wind distribution chamber, a right auxiliary wind distribution chamber, a left auxiliary wind distribution chamber, high-temperature resistant and anti-clogging wind distribution plates, a hot wind pipe and cold wind pipes; the feed inlet is disposed in the middle on the top end of the apparatus, the left dust removal port and the right dust removal port are disposed at the both sides of the feed inlet, the gangue discharging outlet is disposed on the end at the side of the left dust removal port, the fine coal discharging outlet is disposed on the end at the side of the right dust removal port, the drying zone is disposed in the middle in the apparatus, and the left sorting zone and the right sorting zone are disposed at the both sides of the drying zone; the scraper conveyors are disposed in the apparatus, and each scraper conveyor comprises a driven wheel, a driving wheel, a tension wheel and a reverse wheel, and a scraper conveyor belt is wound on the driven wheel, driving wheel, tension wheel and reverse wheel; the high-temperature resistant and anti-clogging wind distribution plates are disposed in the middle in the apparatus, the left auxiliary wind distribution chamber is disposed at the left end of the high-temperature resistant and anti-clogging wind distribution plates in the apparatus, and the right auxiliary wind distribution chamber is disposed at the right end of the high-temperature resistant and anti-clogging wind distribution plates in the apparatus; the hot wind distribution chamber is disposed in the middle under the bottom of the high-temperature resistant and anti-clogging wind distribution plates, and the left wind distribution chamber and the right wind distribution chamber are disposed at the both sides of the hot wind distribution chamber; the bottom of the hot wind distribution chamber is connected to the hot wind pipe, and the bottoms of the left wind distribution chamber and right wind distribution chamber are connected to a cold wind pipe respectively.

Beneficial effects: with the above technical scheme, the integrated apparatus based on pulsating fluidization for de-ashing and dehydration can accomplish lignite upgrading by dehydration and de-ashing in a single operating unit. The integrated apparatus is divided into a drying zone and two sorting zones, according to the flow rate and temperature of the fluidizing wind in the lignite dehydration and sorting process. In the drying zone, hot wind with a cyclically varying airflow rate is fed through a pulsating hot wind system. According to the requirements for lignite drying, the airflow rate and airflow temperature in the drying zone are high, to give fully play to the advantages of pulsating fluidization in mass transfer and heat transfer, to accomplish lignite drying. In the two sorting zones, cold wind is fed from a pulsating cold wind system at a cyclically varying airflow rate; in these zones, the airflow rate is low, and the normal temperature airflow works with a magnetite powder medium solids in the integrated apparatus to form a micro-bubbling quasi-dispersion fluidized bed, i.e., an wind medium solids pulsating fluidized bed; the dried lignite is stratified by density therein, the light product floats to the surface of the bed, while the heavy product settles to the bottom of the bed; conveyed by the scraper conveyors, the products are discharged through the fine coal discharging outlet and the gangue discharging outlet respectively. According to the difference of moisture content and granularity property of the feed lignite, the airflow rate, pressure, temperature and pulsation frequency in the drying zones can be regulated by the PLC conveniently, to attain an optimal drying effect; according to the difference of ash content and sorting property of the feed lignite, the airflow rate, pressure and pulsation frequency in the sorting zone can be regulated by the PLC conveniently, to attain an optimal sorting effect. Finally, an integrated and simplified de-ashing and dehydration upgrading process for lignite with high ash content and high moisture content is realized.

### BRIEF DESCRIPTION OF THE DRAWINGS

FIG. 1 is a control diagram illustrating the air supplying system, and flow rate, temperature and pressure according to the present invention;

FIG. 2 shows the integrated apparatus based on pulsating fluidization for de-ashing and dehydration according to the present invention.

Among the drawings: 1—left dust removal port; 2—right dust removal port; 3—feed inlet; 4—fine coal discharging outlet; 5—gangue discharging outlet; 6—driving wheel; 7—scraper conveyor; 8—driven wheel; 9—drying zone; 10—left sorting zone; 11—right sorting zone; 12—reverse wheel; 13—tension wheel; 14—hot wind distribution chamber; 15—left wind distribution chamber; 16—right wind distribution chamber; 17—right auxiliary wind distribution chamber; 18—left auxiliary wind distribution chamber; 19—high-temperature resistant and anti-clogging wind distribution plate; 20—hot wind pipe; 21—cold wind pipe.

### DETAILED DESCRIPTION

Hereunder the present invention will be detailed in embodiments with reference to the accompanying drawings:

Embodiment 1: integrated method and apparatus based on pulsating fluidization for lignite de-ashing and dehydration:

a. The method is implemented through the following steps:

(1) generation and control of pulsating airflow: air is deoxidized in an air purifier, and then is blasted by a blower into an air storage and pressure regulation tank, the pressure stabilized airflow is split into two branches: the first branch of airflow passes through a first electric valve, a first flow meter, an air heater and a first butterfly valve sequentially, and is used as pulsating drying hot wind; the second branch of air passes through a second electric valve, a second flow meter and a second butterfly valve sequentially, and is used as pulsating sorting cold wind; the airflow rate, temperature, pressure, and pulsation frequency are controlled through sensors, transducer and electric motor, etc. according to the requirements of material properties, and the product specifications of moisture content and ash content by real-time feedback control through a PLC.

(2) dehydration and de-ashing based on pulsating fluidization: the material is fed through a feed inlet 3 into a drying zone 9, the lower part of the drying zone 9 is connected to a hot wind distribution chamber 14 through high-temperature resistant and anti-clogging wind distribution plates 19 and the material fed into the drying zone 9 is dried and dehydrated under the effect of the high flow-rate and high-temperature pulsating airflow supplied through a hot wind pipe 20; the dried material enters into the two cold wind sorting stages(i.e., left sorting zone 10 and right sorting zone 11) under the effect of scraper conveyors 7 which are parallelly arranged up and down inside, the lower parts of two cold wind sorting stages(i.e., left sorting zone 10 and right sorting zone 11) are connected to left normal temperature wind distribution chamber 15 and right normal temperature wind distribution chamber 16 respectively through the high-temperature resistant and anti-clogging wind distribution plates 19, and the dried material in the cold wind sorting stages (i.e., left sorting zone 10 and right sorting zone 11) are sorted and stratified under the effect of low flow-rate and normal temperature pulsating airflow supplied through cold wind pipes 21; the sorted and stratified light products and heavy products are conveyed under the scraper conveyors 7 to a fine coal outlets 4 and gangue discharging outlets 5 at the left and right ends of the sorting machine respectively; thus, the moist material is dried and sorted in an integrated manner.

The apparatus comprises a pulsating airflow generating and controlling apparatus, and an integrated apparatus based on pulsating fluidization for de-ashing and dehydration.

The pulsating airflow generating and controlling apparatus comprises: an air purifier, a blower, a first transducer, a pressure regulation tank, a first electric valve, a second electric valve, a first flow meter, a second flow meter, a heater, a first butterfly valve, a first electric motor, a second transducer, a second butterfly valve, a second electric motor, a third transducer, a pressure sensor, a temperature sensor, a PLC controller, an upper computer and an integrated apparatus based on pulsating fluidization for de-ashing and dehydration; the air purifier is connected to the blower, a output terminal of the PCL controller is connected to the control terminal of the blower through the first transducer; the output port of the blower is connected to the first electric valve and the second electric valve through the pressure regulation tank simultaneously, the first electric valve is connected to a hot wind pipe 20 of the integrated apparatus based on pulsating fluidization for de-ashing and dehydration through the first flow meter, the heater and the first butterfly valve serially, the second transducer is connected to the first butterfly valve through the first electric motor; the second electric valve is connected to a cold wind pipe 21 of the integrated apparatus based on pulsating fluidization for de-ashing and dehydration through the second flow meter and the second butterfly valve, and the third transducer is connected to the second butterfly valve through the second electric motor; an output terminal of the PLC controller is connected to the control terminals of the second transducer and third transducer; an output terminal of the PLC controller is connected to control terminals of the first electric valve and second electric valve simultaneously; the output terminals of the first flow meter, second flow meter, heater, pressure sensor and temperature sensor are connected to the input terminals of the PLC controller.

The integrated apparatus based on pulsating fluidization for de-ashing and dehydration comprises: a left dust removal port 1, a right dust removal port 2, a feed inlet 3, a fine coal discharging outlet 4, a gangue discharging outlet 5, driving wheels 6, scraper conveyors 7, driven wheels 8, a drying zone 9, a left sorting zone 10, a right sorting zone 11, reverse wheels 12, tension wheels 13, a hot wind distribution chamber 14, a left wind distribution chamber 15, a right wind distribution chamber 16, a right auxiliary wind distribution chamber 17, a left auxiliary wind distribution chamber 18, high-temperature resistant and anti-clogging wind distribution plates 19, a hot wind pipe 20 and cold wind pipes 21; the feed inlet 3 is disposed in the middle on the top end of the apparatus, the left dust removal port 1 and the right dust removal port 2 are disposed at the both sides of the feed inlet 3, the gangue discharging outlet 5 is disposed on the end at the side of the left dust removal port 1, the fine coal discharging outlet 4 is disposed on the end at the side of the right dust removal port 2, the drying zone 9 is disposed in the middle in the apparatus, and the left sorting zone 10 and the right sorting zone 11 are disposed at the both sides of the drying zone 9; the scraper conveyors 7 are disposed in the apparatus, and each scraper conveyor 7 comprises a driven wheel 8, a driving wheel 6, a tension wheel 13 and a reverse wheel 12, and a scraper conveyor belt is wound on the driven wheel 8, driving wheel 6, tension wheel 13 and reverse wheel 12; the high-temperature resistant and anti-clogging wind distribution plates 19 are disposed in the middle in the apparatus, the left auxiliary wind distribution chamber 18 is disposed at the left end of the high-temperature resistant and anti-clogging wind distribution plates 19 in the apparatus, and the right auxiliary wind distribution chamber 17 is disposed at the right end of the high-temperature resistant and anti-clogging wind distribution plates 19 in the apparatus; the hot wind distribution chamber 14 is disposed in the middle under the bottom of the high-temperature resistant and anti-clogging wind distribution plates 19, and the left wind distribution chamber 15 and the right wind distribution chamber 16 are disposed at the both sides of the hot wind distribution chamber 14; the bottom of the hot-blast wind distribution chamber 14 is connected to the hot wind pipe 20, and the bottoms of the left wind distribution chamber 15 and right wind distribution chamber 16 are connected to a cold wind pipe 21 respectively.

In the integrated method and apparatus based on pulsating fluidization for lignite de-ashing and dehydration, the integrated drying and sorting process can be divided into the following two units:

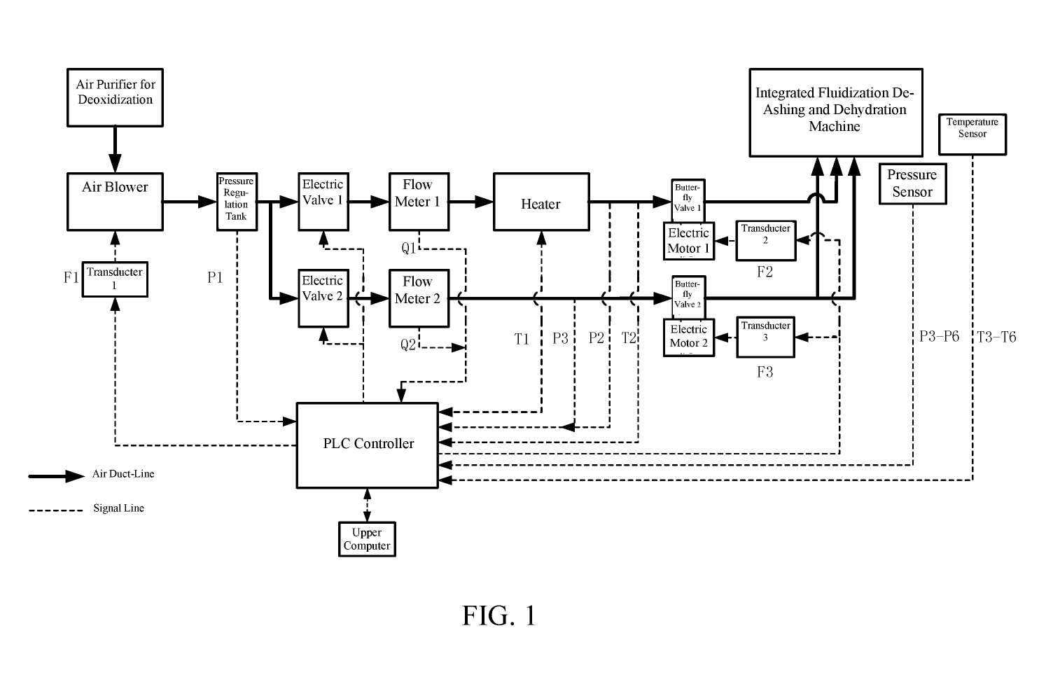

1. Generation and Control of Pulsating Airflow, as Shown in FIG. 1

(1) The air is deoxidized in an air purifier, and then is blasted by the blower which under the control of the first transducer into the air storage and pressure regulation tank. The air in the pressure regulation tank is split into two branches by two electric valves (i.e., the first electric valve and the second electric valve): the first branch of air passes through the first flow meter and heater sequentially, and is used as drying hot wind, the drying hot wind is converted to pulsating drying hot wind with a specific pulsation frequency by the first butterfly valve under the control of the first electric motor through the second transducer, and then the pulsating hot wind is fed into the integrated drying and sorting apparatus; the second branch of air passes through the second flow meter and is used as normal temperature sorting cold wind, the cold wind is converted to pulsating normal temperature sorting cold wind with a specific pulsation frequency by the second butterfly valve under the control of the second electric motor through the third transducer, and then the pulsating normal temperature cold wind is fed into the integrated drying and sorting apparatus.

(2) There is an optimal combining value among the flow rate, pressure and temperature of the pulsating drying hot wind and pulsating sorting cold wind, depending on the specific properties of the material and the requirements of product specification in the integrated drying and sorting apparatus; in the actual operating process, the flow rates Q1 and Q2 of the two flow meters, the pressures P2 and P3, temperatures T1 and T2 and pulsation frequencies of the pulsating hot wind and cold wind, and the variation of temperature and pressure distribution in the integrated apparatus based on pulsating fluidization for de-ashing and dehydration are detected and transmitted to the PLC control system, and, through comparison with the optimal combining value, control signals are fed back to the control and actuating parts of the three transducers, two electric valves, one heater, and two electric motors, so as to optimize the feedback control.

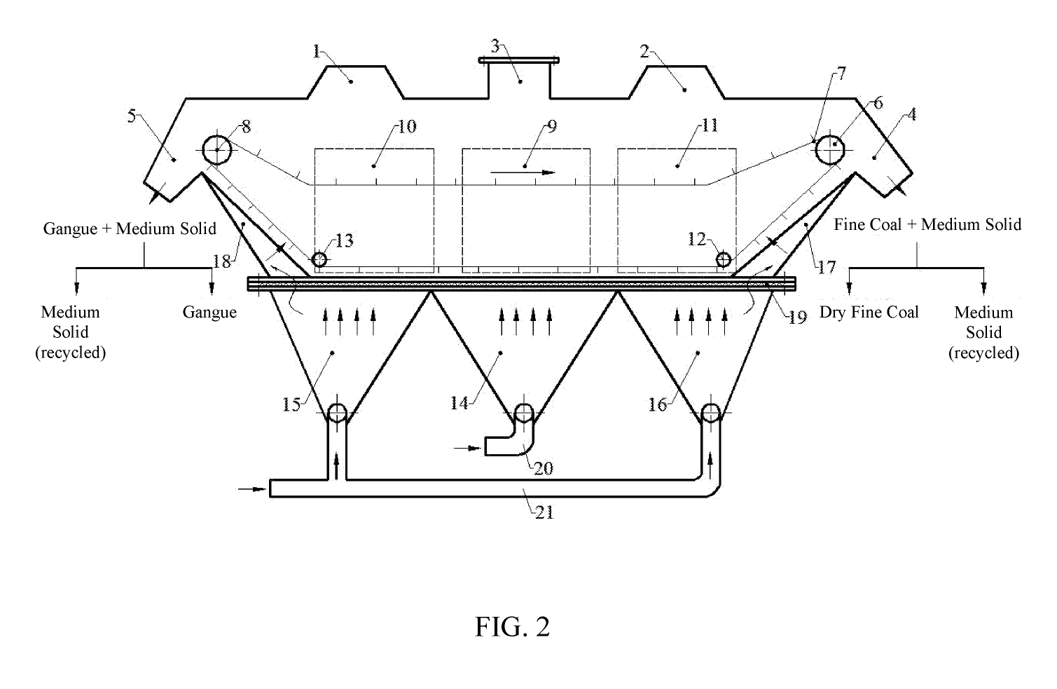

2. Drying and Sorting, as Shown in FIG. 2

The mineral material to be dried and sorted is fed through the feed inlet 3 into the drying zone 9. In the pulsating airflow generation and control process, the pulsating drying hot wind is applied through the hot wind pipe 20 and the hot wind distribution chamber 14 to the material to be dried in the drying zone 9, so as to accomplish material drying and dehydration. The pulsating normal temperature sorting cold wind is applied through the cold wind pipe 21, the left wind distribution chamber 15 and the right wind distribution chamber 16 to the left sorting zone 10 and right sorting zone 11, so as to accomplish sorting and stratification of the dried and dehydrated material. After the material is dried by hot wind and is sorted by cold wind, the products are conveyed by the scraper conveyors 7 which are parallelly arranged up and down inside in the sorting bed to the light product discharging end and heavy product discharging end on the both sides of the sorting machine respectively, and fine coal product and gangue product are discharged by the driving wheel 6 and driven wheel 8 through the fine coal discharging outlet 4 and gangue discharging outlet 5 respectively. The fine coal and gangue products discharged through the fine coal discharging outlet 4 and gangue discharging outlet 5 are treated subsequently for removing the medium, and the sorting medium is purified and recycled. In the conveying and discharging process by the scraper conveyors, the reverse wheels 12 and tension wheels 13 assist reversing and tensioning of the scraper conveyors. In the inclined bed section from the light/heavy product discharging ends to the reverse wheel 12 and tension wheel 13, right auxiliary wind distribution chamber 17 and left auxiliary wind distribution chamber 18 are added to maintain a uniform and stable fluidization environment in the bed, and to effectively avoid the formation of any fluidization dead-zone, at the same time facilitate the conveying and discharging of the sorted and stratified materials. After the drying and sorting, the cold wind that contains vapor and dust is purified and recycled by an air draft device through the left dust removal port 1 and the right dust removal port 2.

The pulsation frequencies of the pulsating drying hot wind and pulsating sorting cold wind are achieved by the PLC through the first electric motor and second electric motor controlled by second transducer and third transducer, and first butterfly valve and second butterfly valve.

In the drying zone 9, a pulsating fluidization-based drying environment that attains a good mass transfer and heat transfer effect is created by the pulsating drying hot wind and a magnetite powder medium solid, so as to accomplish drying and dehydration of the moist lignite quickly; in the cold wind blast sorting stage (i.e., the left sorting zone 10 and the right sorting zone 11), a pulsating fluidization-based sorting environment that attains a good sorting effect is created by the pulsating sorting cold wind and the magnetite powder medium solid, so as to accomplish sorting and stratification of the dried material accurately and quickly.

1. An integrated method based on pulsating fluidization for lignite de-ashing and dehydration a material, comprising:
(1) generating and controlling a pulsating airflow comprising:
deoxidizing air in an air purifier
blowing the deoxidized air by a blower into an air storage and pressure regulation tank, where the air pressure is regulated;
splitting the airflow into two branches a first branch of airflow passing through a first electric valve, a first flow meter, an air heater and a first butterfly valve sequentially, and is used as a pulsating drying hot wind and a second branch of air passing through a second electric valve, a second flow meter and a second butterfly valve sequentially, and is used as pulsating sorting cold wind;
controlling the flow-rate, temperature, pressure, and pulsation frequency of the airflow through sensors, a transducer and an electric motor according to the requirements of the properties of the material, and moisture content and ash content specification of product by real-time feedback control through a PLC; and
(2) dehydrating and de-ashing based on pulsating fluidization comprising:
feeding the material through a feed inlet into a drying zone, the lower part of the drying zone being operably connected to the hot wind distribution chamber through high-temperature resistant and anti-clogging wind distribution plates, and
drying and dehydrating the material fed into the drying zone under the effect of the high flow-rate and high-temperature pulsating dry hot wind airflow supplied through a hot wind pipe;
conveying the dried material into the two cold wind sorting stages under the effect of scraper conveyors which are arranged parallel inside the machine tool, the lower parts of two cold wind sorting stages are connected to left and right normal temperature wind distribution chambers respectively through high-temperature resistant and anti-clogging wind distribution plates, and
sorting and stratifying the dried material in the cold wind sorting stages are sorted and stratified under the effect of low flow-rate and normal temperature pulsating airflow supplied through a cold wind pipe;
conveying the sorted and stratified light products and heavy products by the scraper conveyors to fine coal discharging outlets and gangue discharging outlets at the ends of the sorting machine; thereby drying and sorting the moist material in an integrated manner,
wherein in the drying zone, a pulsating fluidization-based drying environment that attains a good mass transfer and heat transfer effect is created by the pulsating drying hot wind and a magnetite powder medium solid, so as to accomplish drying and dehydration of the moist lignite quickly
and wherein in the left sorting zone and right sorting zone, a pulsating fluidization-based sorting environment that attains a good sorting effect is created by the pulsating sorting cold wind and the magnetite powder medium solid, so as to accomplish sorting and stratification of the dried material accurately and quickly.

2. An apparatus for pulsating fluidization for lignite de-ashing and dehydration comprising:
an pulsating airflow generating and controlling apparatus and an integrated apparatus based on pulsating fluidization for de-ashing and dehydration, the pulsating airflow generating and controlling apparatus comprising:
an air purifier, a blower, a first transducer, a pressure regulation tank, a first electric valve, a second electric valve, a first flow meter, a second flow meter, a heater, a first butterfly valve, a first electric motor, a second transducer, a second butterfly valve, a second electric motor, a third transducer, a pressure sensor, a temperature sensor, a PLC controller, an upper computer, and an integrated apparatus based on pulsating fluidization for de-ashing and dehydration,
wherein the air purifier is connected to the blower, a output terminal of the PCL controller is connected to the control terminal of the blower through the first transducer; the output port of the blower is connected to the first electric valve and the second electric valve through the pressure regulation tank, the first electric valve is connected to a hot wind pipe of the integrated apparatus based on pulsating fluidization for de-ashing and dehydration through the first flow meter, the heater and the first butterfly valve serially, and the second transducer is connected to the first butterfly valve through the first electric motor; the second electric valve electric valve is connected to a cold wind pipe of the integrated apparatus based on pulsating fluidization for de-ashing and dehydration through the second flow meter and the second butterfly valve, and the third transducer is connected to the second butterfly valve through the second electric motor; an output terminal of the PLC controller is connected to the control terminals of the second transducer and third transducer; an output terminal of the PLC controller is connected to control terminals of the first electric valve and second electric valve simultaneously,
wherein the output terminals of the first flow meter, second flow meter, heater, pressure sensor and temperature sensor are connected to the input terminals of the PLC controller,
wherein the integrated apparatus based on pulsating fluidization for de-ashing and dehydration comprises:
a left dust removal port, a right dust removal port, a feed inlet, a fine coal discharging outlet, a gangue discharging outlet, driving wheels, scraper conveyors, driven wheels, a drying zone, a left sorting zone, a right sorting zone, reverse wheels, tension wheels, a hot wind distribution chamber, a left wind distribution chamber, a right wind distribution chamber, a right auxiliary wind distribution chamber, a left auxiliary wind distribution chamber, high-temperature resistant and anti-clogging wind distribution plates, a hot wind pipe and cold wind pipes,
wherein the feed inlet is disposed in the middle on the top end of the apparatus, the left dust removal port and the right dust removal port are disposed at the both sides of the feed inlet, the gangue discharging outlet is disposed on the end at the side of the left dust removal port, the fine coal discharging outlet is disposed on the end at the side of the right dust removal port, the drying zone is disposed in the middle in the apparatus, and the left sorting zone and the right sorting zone are disposed at the both sides of the drying zone,
wherein the scraper conveyors are disposed in the apparatus, and each scraper conveyor comprises a driven wheel, a driving wheel, a tension wheel and a reverse wheel, and a scraper conveyor belt is wound on the driven wheel, driving wheel, tension wheel and reverse wheel,
wherein the high-temperature resistant and anti-clogging wind distribution plates are disposed in the middle in the apparatus, the left auxiliary wind distribution chamber is disposed at the left end of the high-temperature resistant and anti-clogging wind distribution plates in the apparatus, and the right auxiliary wind distribution chamber is disposed at the right end of the high-temperature resistant and anti-clogging wind distribution plates in the apparatus,
wherein the hot wind distribution chamber is disposed in the middle under the bottom of the high-temperature resistant and anti-clogging wind distribution plates, and the left wind distribution chamber and the right wind distribution chamber are disposed at the both sides of the hot wind distribution chamber,
wherein the bottom of the hot wind distribution chamber is connected to the hot wind pipe, and the bottoms of the left wind distribution chamber and right wind distribution chamber are connected to a cold wind pipe respectively,
wherein there is an optimal combining value among the flow rate, pressure and temperature of the pulsating drying hot wind and pulsating sorting cold wind, depending on the specific properties of the material and the requirements of product specification in the integrated drying and sorting apparatus;
in the actual operating process, the flow rates Q1 and Q2 of the two flow meters, the pressures P2 and P3, temperatures T1 and T2 and pulsation frequencies of the pulsating hot wind and cold wind, and the variation of temperature and pressure distribution in the integrated apparatus based on pulsating fluidization for de-ashing and dehydration are detected and transmitted to a PLC control system, and, control signals are fed back to the control and actuating parts of the three transducers, two electric valves, one heater, and two electric motors to optimize the feedback control by comparing with the optimal combining value.
